(19) United States
(12) Patent Application Publication
(10) Pub. No.: US 2016/0381177 A1
(43) Pub. Date: Dec. 29, 2016

(54) MANAGING DATA REQUESTS

(71) Applicant: QUALCOMM Incorporated, San Diego, CA (US)

(72) Inventors: Lorenz Christoph Minder, Evanston, IL (US); Michael George Luby, Berkeley, CA (US)

(21) Appl. No.: 14/816,123

(22) Filed: Aug. 3, 2015

Related U.S. Application Data
(60) Provisional application No. 62/184,964, filed on Jun. 26, 2015.

(51) Int. Cl. H04L 29/08

(52) U.S. Cl. CPC H04L 67/327; H04L 67/02; H04L 67/16

(57) ABSTRACT

Various embodiments enable managing data requests made by a receiver device for delivery of content segments to the receiver device. A processor may determine a first number of first chunk requests including a first amount of data requested for a content segment. The processor may send the first chunk requests to one or more servers and may receive first data responses at a receiving rate. The processor may determine whether sufficient data responses might not be received by the receiver device in time to recover the content segment by a time deadline associated with the content segment. In response to determining that sufficient data responses to the first chunk requests might not be received by the time deadline, the processor may determine a second number of one or more second chunk requests for the content segment and a second amount of data to request from the one or more servers.

### RELATED APPLICATIONS

This application claims the benefit of priority to U.S. Provisional Patent Application No. 62/184,964 entitled “Managing Data Requests” filed Jun. 26, 2015, the entire contents of which are hereby incorporated by reference.

### BACKGROUND

Providing streamed content from a sending network to a receiving device over data networks has become commonplace. When content is streamed, a portion of the content may be received and decoded by the receiving device before all of the content data is sent by the sending network device. Many widely used transport protocols, such as Transport Control Protocol (TCP), work well for one-to-one reliable communications when there is little data loss between the sender and the recipient and the round trip time between the sender and the recipient is relatively brief. However, the throughput achieved by most protocols may fall dramatically when there is even a small amount of data loss during transport, or when the sender and the recipient are relatively far apart. Generally, two mechanisms may be used, alone or together, to compensate for data loss across a transport network: packet retransmission, and forward error correction (FEC). When data is not time sensitive (i.e., not latency sensitive), a receiver (e.g., a mobile communication device) may send packet retransmission requests back to the sending network element when requested data is not received by the receiver.

### SUMMARY

The various embodiments include methods for managing data requests made by a processor of a receiver device for delivery of content segments to the receiver device that may include determining a first number of first chunk requests for a content segment, the first chunk requests identifying a first amount of requested data, sending the first chunk requests to one or more servers, receiving from the one or more servers first data responses to the first chunk requests at a receiving rate, determining whether sufficient data responses to the first chunk requests might not be received by the receiver device to recover the content segment by a time deadline associated with the content segment, determining a second number of one or more second chunk requests for the content segment and a second amount of data to request via the one or more second chunk requests in response to determining that sufficient data responses to the first chunk requests might not be received to recover the content segment by the time deadline associated with the content segment, wherein the second number and the second amount of data are based on the receiving rate of the first data responses and the time deadline associated with the content segment, and sending the one or more second chunk requests to the one or more servers. In some embodiments determining whether sufficient data responses to the first chunk requests might not be received by the receiver device to recover the content segment by a time deadline associated with the content segment may include determining a probability that sufficient data responses to the first chunk requests will be received to recover the content segment by the time deadline. In some embodiments the receiving rate is not predictable by the processor when the processor sends the first chunk requests.

In some embodiments determining a second number of one or more second chunk requests for the content segment and a second amount of data may include determining the second number of one or more second chunk requests and the second amount of data such that a probability that sufficient data responses to the first chunk requests and the one or more second chunk requests will be received to recover the content segment by the time deadline exceeds a defined threshold. In some embodiments the second amount of data may include a composition based on the time deadline associated with the content segment, the received data responses, and data responses not yet received, wherein the composition is one of additional source data of the content segment, repair data for the content segment, and a combination of repair data for and additional source data of the content segment. In some embodiments the composition is further based on a layer priority associated with the content segment. In some embodiments the composition may include one or more of an amount of the additional source data of the content segment and an amount of the repair data for the content segment, wherein the amount of the additional source data of the content segment and the amount of the repair data for the content segment are based on one or more of the time deadline associated with the content segment, the received data responses, data responses not yet received, and a layer priority associated with the content segment. Some embodiment methods may further include recovering the content segment when the request manager receives sufficient data responses to chunk requests to recover the content segment.

In some embodiments the first chunk requests and the one or more second chunk requests include Hypertext Transfer Protocol/Transmission Control Protocol (HTTP/TCP) requests for one or more ranges of data of the content segment. In some embodiments the aggregate size of all of the first amount of data and the second amount of data is greater than a size of the content segment.

Various embodiments may include a receiver device including a processor configured with processor-executable instructions to perform operations of the methods described above. Various embodiments may include a receiver device including means for performing functions of the methods described above. Various embodiments may include a non-transitory processor-readable storage medium having stored thereon processor-executable instructions configured to cause a processor to perform operations of the methods described above.

### BRIEF DESCRIPTION OF THE DRAWINGS

The accompanying drawings, which are incorporated herein and constitute part of this specification, illustrate exemplary embodiments of the various embodiments, and together with the general description given above and the detailed description given below, serve to explain the features of the various embodiments.

FIG. 1 is a block diagram of a communication system suitable for use with the various embodiments.

FIG. 2 is a block diagram of a communication system suitable for use with the various embodiments.

FIG. 3 is a process flow diagram illustrating a method for managing data requests made by a request manager of a receiver device for delivery of content segments to the receiver device according to various embodiments.

FIG. 4 is a process flow diagram illustrating another method for managing data requests made by a request manager of a receiver device for delivery of content segments to the receiver device according to various embodiments.

FIG. 5 is a process flow diagram illustrating another method for managing data requests made by a request manager of a receiver device for delivery of content segments to the receiver device according to various embodiments.

FIG. 6 is a component block diagram of a mobile communication device suitable for implementing various embodiments

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the various embodiments or the claims.

The various embodiments provide methods, and devices configured to implement the methods, that determine the amount of forward error correction (FEC) data to request with requested content chunks based on both the network state and the deadline time for receiving a requested chunk. The various embodiments enable better use of bandwidth because the overhead communication of FEC data may be reduced, particularly when the time remaining before a deadline time of a requested chunk would permit recovery of lost data via retransmission requests.

As used herein, the term “receiving device” and “mobile communication device” are used interchangeably herein to refer to any one or all of cellular telephones, smartphones, personal or mobile multi-media players, personal data assistants (PDAs), laptop computers, tablet computers, smartbooks, palmtop computers, wireless electronic mail receivers, multimedia Internet enabled cellular telephones, wireless gaming controllers, personal computers, television set top boxes, televisions, cable television receivers, and similar personal electronic devices which include a programmable processor, memory and circuitry for receiving and presenting media content.

The term “server” is used to refer to any computing device capable of functioning as a server, such as a web server, an application server, a content server, a multimedia server, or any other type of server. A server may be a dedicated computing device or a computing device including a server module (e.g., running an application which may cause the computing device to operate as a server).

The terms “component,” “module,” “system,” and the like as used herein are intended to include a computer-related entity, such as, but not limited to, hardware, firmware, software, a combination of hardware and software, or software in execution, that is configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

To compensate for data lost (i.e., corrupted or not received) during transmission across a transport network, a packet retransmission mechanism and a forward error correction (FEC) mechanism may be used, alone or in combination. However, in some circumstances packet retransmission requests and subsequent retransmission of data may take too long to satisfy requirements of a latency- or delay-sensitive application. In such cases, the receiving device may request additional FEC repair data be included in transmitted data packets, and the sending device may responsively increase the amount of repair data included with content data in transmitted packets. The receiving device may use the repair data included with the transmitted content data to reconstruct any missed content data within the latency constraints of the application.

The systems, methods, and devices of the various embodiments may determine in real time an amount of repair data to request for a segment of content, which is referred to herein as a “chunk” (i.e., a portion of the content to be sent from the sender to the receiver). A receiving device, such as a mobile communication device, may adjust the amount of repair data that the receiving device requests with each chunk request to an amount that is needed to repair received content data under the current network conditions, but avoid requesting too much repair data, thus reducing the FEC overhead in the communication stream. For example, requesting too much repair data may reduce the available data rate by consuming data transport capability that could be used for carrying content data, while requesting too little repair data may result in degraded performance of the application, such as a media or content stall.

In some embodiments, a processor of the receiving device may automatically determine the amount of repair data to request in order to avoid manual adjustment of parameters for varying network conditions (e.g., packet error rate). For example, when the network packet error rate is relatively low (or is zero), the processor may adjust the amount of repair data requested such that application performance is no worse than an application for which no repair data is requested (i.e., the amount of repair data requested does not substantially affect data throughput to the application). Further, when the network packet error rate is relatively high, the processor may adjust the amount of requested repair data to substantially outperform an application for which no repair data is requested. In addition to potentially measuring loss directly, the application may receive other information that is indicative or highly correlated with packet loss. For example, a decrease in the receiving rate of a TCP flow may indicate that one or more content packets was lost in the TCP flow.

Requested content (e.g., a media stream, data for interactive applications such as gaming or communication applications, latency sensitive data for a web browser, and other similar content) may be divided into segments, with each segment having a time deadline by which enough data of the segment must be received and decoded (e.g., for use by, or for presentation by, an application of the receiving device). Data of the segment may be requested in chunks, and each chunk request can specify content data (i.e., source data) and repair data (e.g., FEC data), as well as an amount of content data and/or repair data. In the process of receiving a stream of content data, the receiving device may issue one or more chunk requests for a segment, and receive data responsive to the chunk requests until a sufficient amount of content data has been received to decode the requested segment.

In some embodiments, the processor of the receiving device may monitor the receipt of data responsive to the one or more chunk requests. When the processor determines that sufficient content data is arriving as expected or required by the rendering application in response to a set of chunk requests for a segment, the processor may send no further chunk requests for that segment. However, when the processor determines that insufficient content data is arriving as expected or required by the rendering application in response to the set of chunk requests, such that the processor may be unable to decode the content segment by the segment's time deadline, the processor may send a number of second chunk requests for the content segment. In some embodiments, the second chunk request may include a second amount of requested data. In some embodiments, the second number of chunk requests and the second amount of requested data may be based on a determined probability that sufficient responses to the first chunk requests will be received to enable the processor to decode the content segment by the associated time deadline.

In some embodiments, the receiving device may periodically redetermine the probability that sufficient content data is arriving as expected or required by the rendering application, and the receiving device may dynamically adjust its behavior based on the redetermined probability. For example, the receiving device may initially determine that the estimated probability of success for a segment is large enough (e.g., the probability meets or exceeds a threshold), and the receiving device may not send further chunk requests for that segment. However, subsequent reception of content data may be slower or more irregular than initially determined. The receiving device may redetermine the probability that sufficient content data is arriving as expected or required by the rendering application, and the redetermined probability may be lower than the threshold. In response to determining that the redetermined probability is below the threshold, the receiving device may send chunk additional requests for the corresponding segment.

The systems, methods, and devices of the various embodiments may enable a request manager implemented in a processor of a receiving device to determine whether to request an additional chunk of data related to a content segment in the form of repair data and/or content data, based upon whether the segment will be received and decoded in time to play in sequence with previously requested chunks of data for the segment.

In some embodiments, the processor of the receiving device (e.g., a streaming media client) may receive a request for content and may send chunk requests for a segment of the content (i.e., a content segment). The processor may monitor segment data received in response to the chunk requests (i.e., completed chunk requests) and segment data that is requested but not yet received (i.e., outstanding chunk requests). Based on previous chunk reception results (e.g., request time vs. transmission time and/or reception times) for chunk requests for the current segment and/or chunk requests for previously requested segments, a time deadline associated with the content segment, the completed chunk requests, and the outstanding chunk requests, the receiving device processor may estimate a probability that the application of the receiving device will receive enough data of the content segment to decode the segment by the associated time deadline.

When the estimated probability that the application of the receiving device will receive enough data of the content segment to decode the segment by the associated time deadline is below a threshold, the receiving device processor may send a new chunk request for additional data, the additional data request being configured to enable the application of the receiving device to receive sufficient data of the segment to decode the segment to meet the time deadline. The new chunk request(s) may be for more repair data to enable recovery of content data lost in the received chunks, for additional data for the segment, or a combination of additional content data and repair data. For example, when the probability that the rendering application will receive sufficient content data to decode the segment by the associated time deadline is low (i.e., it is unlikely that the segment will be received and decoded in time to meet the time deadline), the receiving device processor may make one or more additional chunk requests for additional data (i.e., for repair data and/or content data) to increase the probability that the application will receive and render the segment by the content segment playback deadline.

Thus, rather than giving up on a content segment that is not being received fast enough for rendering (i.e., accepting a gap or content stall), the receiving device processor determines the amount and type of data that it needs to receive in order to render the segment by the corresponding segment deadline and issues additional chunk requests for the determined necessary data. This method may repeat with the receiving device processor issuing additional chunk requests until the segment time deadline is reached.

In some embodiments, the processor of the receiving device may determine the size and content of data requested in the chunk request (e.g., a number of bytes) based on the time deadline associated with the content segment, the completed chunk requests, and the outstanding chunk requests. The composition of data requested in the chunk request(s) may be determined based on the segment time deadline, the data and delivery timing of completed chunk requests, and the outstanding chunk requests. For example, the chunk request(s) may include a request for source data, for repair data, or a combination of source and repair data depending upon the data that has already been received. The processor may also determine the size and composition of the chunk request(s) based on observed network conditions, e.g., a level of network congestion, noise, lag, round trip time (RTT), and other network conditions.

In some embodiments, the processor may also determine an importance of the data that is yet to be received based on the segment playback deadline, the completed chunk requests, and the outstanding chunk requests. The processor may use the determined importance of the data to determine whether to send one or more additional chunk requests. For example, missing data belonging to a base layer segment of a media stream may have a relatively high importance, so if some of that data is yet to be received, another chunk request may be made for that segment. On the other hand, if the missing data belongs to an enhancement layer segment, which may have relatively low importance, no additional request may be made for that segment. Examples of such layered video codes includes S-H.264 (a scalable version of H.264, wherein H.264 is also known as AVC), and SHVC (a scalable version of HEVC, wherein HEVC is also known as H.265).

In some embodiments, the processor may use the segment size to decide whether to send another chunk request as well as the composition of the chunk request. Typically, relatively more repair data may be required to accurately decode relatively small segments, so when the segment is relatively small the additional chunk request(s) for repair data may be relatively larger, although in absolute size the amount of data needed to recover smaller segments may be smaller than the amount of data needed to recover larger segments.

The various embodiments may be applied to all types of content streaming, including RTP streaming, progressive download streaming based on HTTP, and adaptive streaming standards, such as DASH, Adobe Systems HTTP Dynamic Streaming, Apple's HTTP Live Streaming (HLS) and Microsoft Smooth Streaming.

The receiving device processor may be configured with processor-executable software instructions to execute a request manager module that may send one or more requests (e.g., HTTP requests over TCP/IP) for the content data to one or more content servers to obtain content data for a client application. The request manager may buffer the content data in memory as it is received (i.e., temporarily store the data in memory), and then deliver a portion of the received data to an application, such as a media player, executing on a processor of the receiving device for decoding and presentation. In some embodiments, the request manager and the client application may be co-located, such as separate modules or applications executing within the mobile communication device. In some embodiments, the request manager may include a transport accelerator, which may receive the content data over multiple data transport streams (e.g., transport control protocol (TCP) connections) carried by a network (e.g., the Internet) from a server or multiple servers, to increase a rate of delivery of content data to the client application.

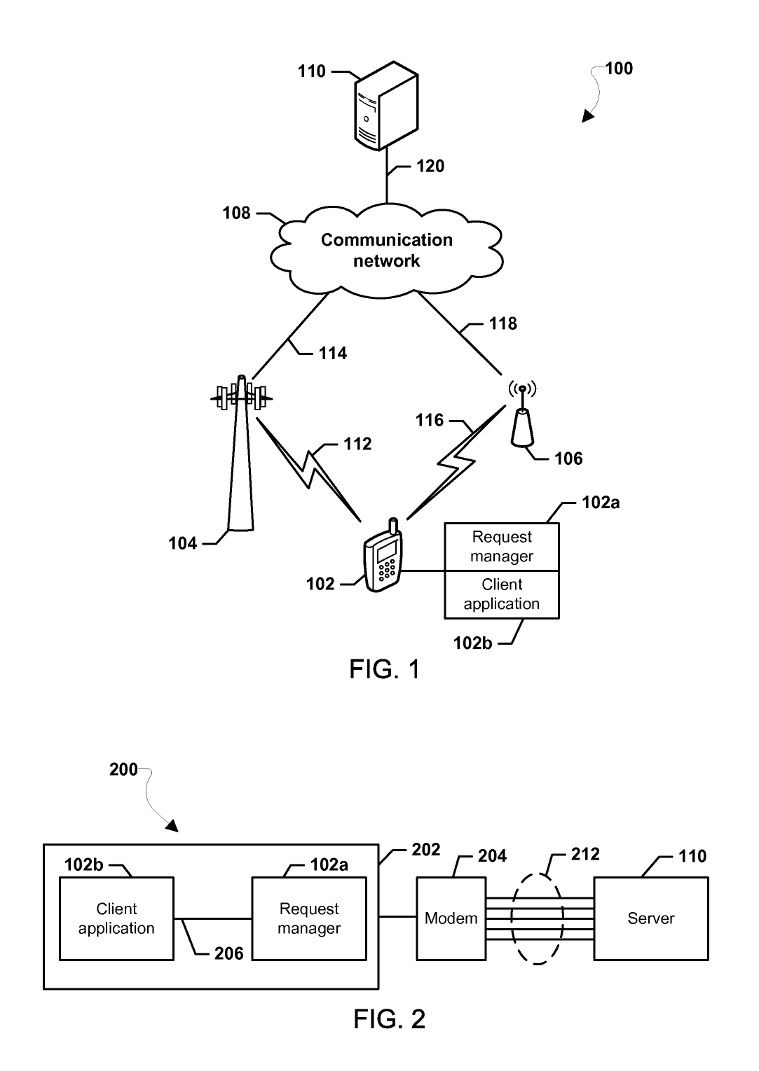

Various embodiments may be implemented in a variety of computing devices that receive content data over a network (e.g., the Internet), such as mobile communication devices that may operate within a wireless communication system 100, an example of which is illustrated in FIG. 1.

Referring to FIG. 1, a receiver device in the form of a mobile communication device 102 may communicate with a communication network 108 that may include a base station 104, an access point 106, and a server 110. The base station 104 may communicate with the communication network 108 over a wired or wireless communication link 114, and the access point 106 may communicate with the communication network 108 over a wired or wireless communication link 118. The communication links 114 and 118 may include fiber optic backhaul links, microwave backhaul links, and other communication links. In some embodiments, the communication network 108 may include a mobile telephony communication network. The mobile communication device 102 may communicate with the base station 104 over a wireless communication link 112, and with the access point 106 over a wireless communication link 116. The server 110 may be an application server, a content server, a media server, or another network node or network element configured to provide content data for a client application 102b, e.g., on the mobile communication device 102. The server 110 may communicate with the communication network 108 over a wired or wireless communication link 120. The mobile communication device 102 may send requests for content data, such as multimedia content, to the server 110 over the communication network 108, requesting delivery of the content data to the client application 102b. In response, the server 110 may stream the requested content data to the mobile communication device 102 over one or more wired or wireless communication links 120. In some embodiments, the mobile communication device 102 may receive the requested content data over a single interface (e.g., over a cellular communication interface, or over a Wi-Fi communication interface). In some embodiments, the mobile communication device 102 may receive the content data over multiple interfaces (e.g., over Wi-Fi and cellular communication interfaces), and the mobile communication device 102 may receive multiple parallel streams over the multiple network interfaces.

The communication network 108 may support communications using one or more radio access technologies, and each of the wireless communication links 112 and 116 may include cellular connections that may be made through two-way wireless communication links using one or more radio access technologies. Examples of radio access technologies may include (3GPP Long Term Evolution) LTE, LTE Advanced, Worldwide Interoperability for Microwave Access (WiMAX), Code Division Multiple Access (CDMA), Time Division Multiple Access (TDMA), Wideband CDMA (WCDMA), GSM, a radio access protocol in the IEEE 802.11 family of protocols (e.g., Wi-Fi), and other radio access technologies. While the communication links 112 and 116 are illustrated as single links, each of the communication links may include a plurality of frequencies or frequency bands, each of which may include a plurality of logical channels.

A processor within the receiver device may execute processor-executable instructions that include a request manager 102a, which may send one or more requests (e.g., HTTP requests over TCP/IP) for the content data to one or more content servers to obtain content data for a client application. The request manager 102a may buffer the content data as it is received (i.e., temporarily store the data in memory), and then deliver a portion of the received data to an application referred to herein as a client application 102b, such as a media player, for decoding and presentation. In some embodiments, the request manager and the client application may be co-located, such as separate modules or applications executing within a processor of the receiver device (e.g., a mobile communication device). In some embodiments, the request manager may include a transport accelerator module or executable instructions (referred to herein as a “transport accelerator”), which may receive the content data over multiple data transport streams (e.g., transport control protocol (TCP) connections) carried by a network (e.g., the Internet) from a server or multiple servers, to increase a rate of delivery of content data to the client application.

FIG. 2 illustrates interactions of the request manager 102a and client application 102b executing in a processor 202 of a receiver device in receiving content data from a server 110 in a communication system 200 suitable for use with the various embodiments. As described above, a processor 202 of mobile communication device may execute a software module that functions as a request manager 102a, which may send one or more requests for content data via a modem 204 (e.g., a wireless network modem) to one or more servers 110 to obtain content data for a client application 102b. To increase the rate at which content data is delivered to the client application 102b, the request manager 102a may receive the content data over multiple streams 212 (e.g., multiple HTTP requests sent over multiple TCP connections) via the modem 204 from the server 110. Received content data may be buffered in a memory (not shown in FIG. 2) used by the request manager 102a as a buffer and delivered to the client application 102b via internal signals 206 (e.g., copying content data into memory registers used by the client application, informing the client application of memory registers in which content data is stored, etc.). In some embodiments, the request manager 102a and the client application 102b may be combined, e.g., into one software module.

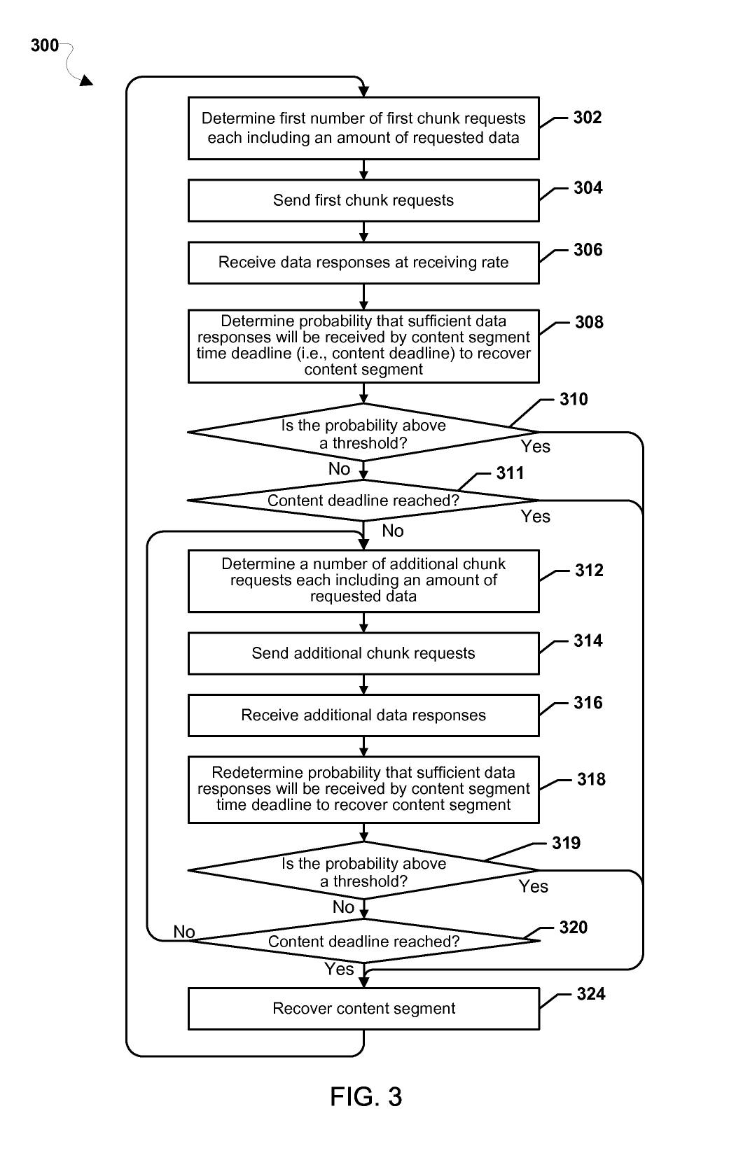

FIG. 3 illustrates a method 300 for managing data requests made by a request manager of a receiver device for delivery of content segments to the receiver device according to various embodiments. The method 300 may be implemented by a processor 202 of the receiver device performing or controlling operations of a request manager (e.g., the request manager 102a of FIG. 1). In block 302, a processor 202 of a receiver device (e.g., the mobile communication device 102 of FIG. 1) may request the delivery of content data of a content segment from a server (e.g., the server 110 of FIG. 1) by determining a first number of first chunk requests, in which each request includes an amount of requested data of the content segment. In some embodiments, the requested data may include a range of data of the content segment, such as a byte range of data. In block 304, the processor may send the first chunk requests to a content server via a network (e.g., the Internet).

In block 306, the processor may receive first data responses from the content server at a receiving rate. The first data responses may include content data and/or repair data for the content segment. The content segment may be associated with a time deadline by which an application executing on a processor of the receiver device needs to decode the content segment, e.g., to meet a threshold level of performance. In some situations, the receiving rate is not predictable by the request manager when the request manager sends the first chunk requests, such as when the network conditions are changing or the receiver device is traveling through a series of network cells.

In block 308, the processor may determine a probability that sufficient data responses to the first chunk requests will be received by the request manager to enable the processor to decode or recover the content segment by the content segment time deadline (i.e., the time deadline associated with the content segment, also referred to as the content deadline). In some embodiments, the processor may monitor segment data received in response to chunk requests, as well as segment data that is requested but not yet received. The processor may determine the probability that the application of the receiving device will receive enough data of the content segment to decode the segment by the associated time deadline based on previous reception results (e.g., transmission time and/or reception times) of the first data responses for the current segment and/or the data responses for previously requested segments of previous chunks, the time deadline associated with the content segment, the completed chunk requests, and the outstanding chunk requests.

In determination block 310, the processor may determine whether the probability determined at block 308 is above a first threshold probability. In response to determining that the probability determined at block 308 is above the first threshold (i.e., determination block 310=“Yes”), the processor may send no further chunk requests, and the processor may recover the content segment in block 324. In some embodiments, the processor may wait to recover the content segment until the processor receives sufficient data to decode substantially the entirety of the requested content segment, or until the content segment time deadline has been reached, whichever occurs first. The processor may then return to the operations in block 302 to determine a number of first chunk requests (e.g., for a new content segment).

In response to determining that the probability determined at block 308 is not above the first threshold (i.e., determination block 310=“No”), the processor may determine whether the content deadline has been reached in determination block 311. In response to determining that the content deadline has been reached (i.e., determination block 311=“Yes”), the processor may recover from received data the content segment in block 324. In this case, only a portion of the content segment may be recoverable, i.e., less than all of the content segment.

In response to determining that the content deadline has not been reached (i.e., determination block 311=“No”), the processor may determine a number of additional chunk requests in block 312. Each additional chunk request may include an amount and type of data to be requested for the content segment. In some embodiments, the number of additional chunk requests and/or the amount of data in the additional chunk requests may be based on the probability determined at block 308, the receiving rate of the first data responses, the time deadline associated with the content segment, one or more other factors, or any combination thereof. The additional chunk requests may request FEC repair data to enable recovery of the segment, and the amount of FEC requested may be based on the probability determined at block 308, the receiving rate of the first data responses, the time deadline associated with the content segment, one or more other factors, or any combination thereof. The additional chunk requests may also request portions of data missing from received chunks or data from chunks requested, but not yet received. In block 314, the processor may send the additional chunk requests, and in block 316 the request manager may receive additional data responses sent by the server in response to the additional chunk requests.

In block 318, the processor may redetermine a probability that sufficient additional data responses will be received by the request manager to enable the processor to decode or recover the content segment by the time deadline associated with the content segment. In some embodiments, the processor may monitor segment data received in response to the additional chunk requests, as well as segment data that is requested but not yet received. The processor may determine the probability that the application of the receiving device will receive enough data of the content segment to decode the segment by the associated time deadline based on previous reception results (e.g., transmission time and/or reception times) of the first data responses, the additional data responses for the current segment and/or the data responses for previously requested segments of previous chunks, the time deadline associated with the content segment, the completed chunk requests, and the outstanding chunk requests.

In determination block 319, the processor may determine whether the probability determined in block 318 is above the threshold probability (e.g., the threshold probability of determination block 310). In response to determining that the probability is above the threshold (i.e., determination block 319=“Yes”), the processor may recover received content segments in block 324. In this case, the processor may wait to recover the content segment until the processor receives sufficient data to decode substantially the entirety of the requested content segment, or until the content segment time deadline is reached, whichever occurs first.

In response to determining that the probability is not above the threshold (i.e., determination block 319=“No”), the processor may determine whether the deadline time for the content segment has been reached in determination block 320. In response to determining that the content deadline time is reached (i.e., determination block 320=“Yes”), the processor may recover the content segment in block 324. In this case, only a portion of the content segment may be recoverable, i.e., less than all of the content segment. In some embodiments, when the content deadline time is reached before sufficient data responses will be received to enable the processor to recover (i.e., decode) the content segment, the processor may discard or skip the content segment and determine chunk requests for a next content segment. In response to determining that the content deadline time is not reached (i.e., determination block 320=“No”), the processor may again determine a number of additional chunk requests in block 312 and continue executing the operations of the method 300 as described above.

In some embodiments, the processor may concurrently process more than one content segment at substantially the same time. For example, active intervals of time for processing different content segments may overlap, wherein the active interval of time for a content segment is a time between the receipt of segment content data by the receiving device and the content deadline time for the content segment. Thus, in some embodiments, the processor may perform the operations of blocks 302-324 concurrently on two or more content segments at substantially the same time. The processor may perform additional steps to determine a relative priority of making chunk requests for the more than one active content segments. For example, the processor may determine relative priorities of the more than one active content segments based on a layer priority of each content segment. In some embodiments, in response to determining that two segments have the same layer priority, the processor may prioritize content data based on an age of a previous chunk request (i.e., an older or newer chunk request). In some embodiments, the processor may prioritize older chunk requests, and in some embodiments, the processor may prioritize newer chunk requests. The age of a chunk request may be determined from the time when the chunk request was created. Additionally or alternatively, the age of a chunk request may be determined from the content deadline. In some embodiments, the processor may associate a fixed tie-breaker value v to each segment request, and the processor may prioritize the segment request with the higher scoring tie-breaker value whenever the indicated layer priority is the same. Such a tie-breaker value may, for example, be chosen pseudo-randomly or as a value from a low-discrepancy sequence.

In some embodiments, the processor may execute an instance of the method 300 for each of multiple content segments. Such executions may be sequential, concurrent, asynchronous, or any combination thereof. In some embodiments, certain decisions that are made in some executions may depend on other executions. By repeating for each such execution the operations of determining the probability that sufficient data will be received in response to each set of chunk requests to enable recovery of the content segment by the segment time deadline in block 318, the various embodiments enable the processor to dynamically adjust the amount of repair data and/or content data to request in each set of chunk requests in response to changing network conditions. Since network conditions may change over time due to network congestion, receiving device mobility, transmission signal (e.g., RF interference in a wireless communication system), or other factors affecting network conditions, the rate at which the receiver device receives content data may change frequently. Thus the various embodiments enable the amount of repair data requested in each chunk request to be adjusted consistent with network conditions, enabling reliable reception of the content data without requesting an unnecessary amount of repair data. In some embodiments, the processor may determine whether sufficient data responses to the first chunk requests might not be received by the receiver device to recover the content segment by the time deadline associated with the content segment, which may include, for example, determining the probability in block 308, one or more other determinations (such as, determining whether the content deadline has been reached in determination block 311), or a combination thereof. In such embodiments, the processor may, in response to determining that sufficient data responses to the first chunk requests might not be received by the receiver device to recover the content segment by the time deadline associated with the content segment, determine the number of additional chunk requests in block 312 (as discussed above) and send the additional chunk requests in block 314 (as discussed above). In further embodiments, the processor may determine whether sufficient data responses to these additional chunk requests might not be received by the receiver device to recover the content segment by the time deadline associated with the content segment, which may include, for example, determining the probability in block 318, one or more other determinations (such as, determining whether the content deadline has been reached in determination block 319), or a combination thereof. In such embodiments, the processor may, in response to determining that sufficient data responses to these additional chunk requests might not be received by the receiver device to recover the content segment by the time deadline associated with the content segment, determine the number of yet additional chunk requests in block 312 and send the yet additional chunk requests in block 314.

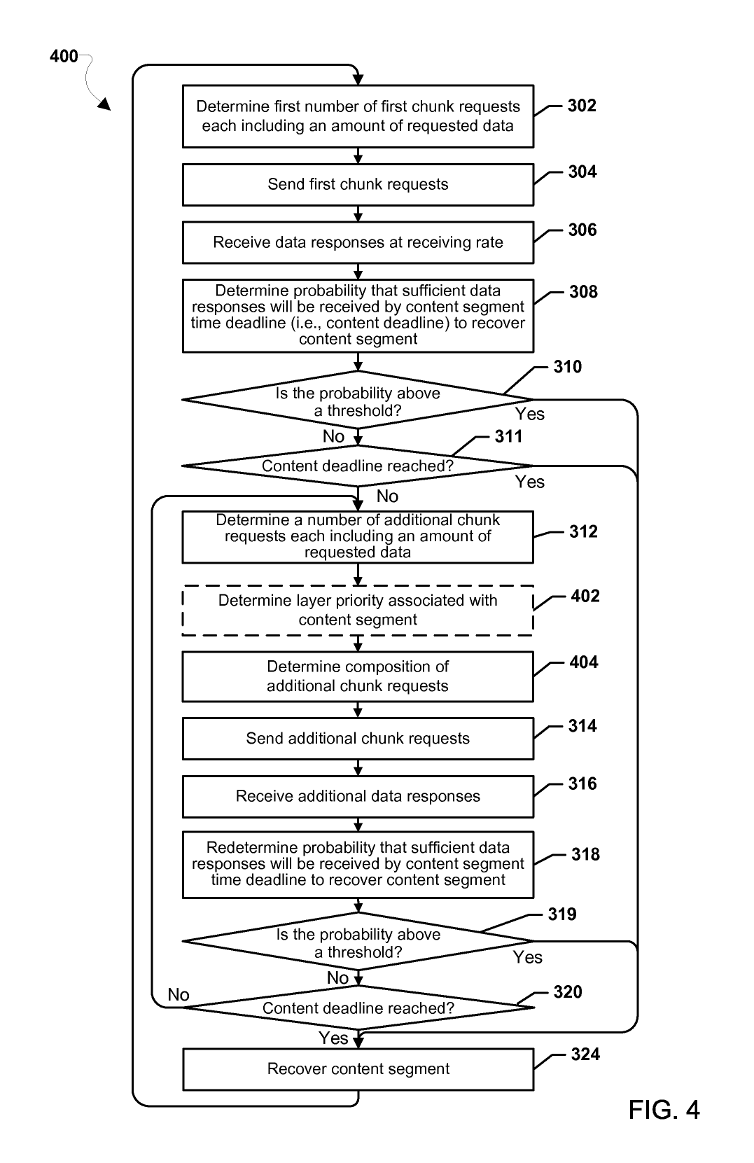

FIG. 4 illustrates another method 400 for managing data requests made by a request manager of a receiver device for delivery of a content segment to the receiver device according to some embodiments. The method 400 may be implemented by a processor 202 of the receiver device performing or controlling operations of a request manager (e.g., the request manager 102a of FIG. 1). The processor may perform the operations of blocks 302 through 312 as described above with reference to FIG. 3.

In optional block 402, the composition of the additional chunk requests may be based on a layer priority associated with the content segment. For example, the content segment may be associated with a layer of the content, such as a base layer, an enhancement layer, or another portion of the requested content. In some embodiments, a base layer may include content data that is required for decoding and/or rendering of the content, and an enhancement layer may include content data that is not required for content decoding and/or rendering, but may be used to enhance the decoding and/or rendering of the content. For example, the enhancement layer may provide data that may be used to increase a playback resolution of the content. Based on the importance of the content layer the content layer may be associated with a layer priority. For example, a base layer may be associated with a higher priority than an enhancement layer. In some embodiments, the processor may determine the composition of the additional chunk requests based on the layer priority associated with the content segment. For example, the processor may request more repair data for a higher priority layer, and may request less repair data for a lower priority layer.

In block 404, the processor may determine a composition of the additional chunk requests. In some embodiments, the additional amount of data to request in each additional chunk request may include a composition of data, which may include additional source data of the content segment, repair data (e.g., FEC data) for the content segment, or a combination of repair data for and additional source data of the content segment. Thus, the composition may include an amount of additional source data and/or an amount of repair data. The composition (including the amount of the additional source data and/or the amount of repair data) may be based the time deadline associated with the content segment, the received data responses, and data responses not yet received by the request manager. The composition may further be based on the layer priority associated with the content segment.

The processor may then perform the operations of blocks 314 through 324 as described above with reference to FIG. 3. In some embodiments, the processor may execute an instance of the method 400 for each of multiple content segments. Such executions may be sequential, concurrent, asynchronous, or any combination thereof. In some embodiments, certain decisions that are made in some executions may depend on other executions. For example, a decision on how much data to request for a content segment associated with a layer priority in one execution may depend on a state of the execution for a content segment associated with a different layer priority.

In some embodiments in which media layers are being transmitted and rendered, each segment and/or chunk request may include a layer priority. The processor may process requests for higher priority layers before requests for lower priority layers. When requests include the same layer priority, the processor may prioritize content data based on an age of a previous chunk request (i.e., an older or newer chunk request). In some embodiments, the processor may prioritize older chunk requests, and in some embodiments, the processor may prioritize newer chunk requests. The age of a chunk request may be determined from the time when the chunk request was created. Additionally or alternatively, the age of a chunk request may be determined from the content deadline. In some embodiments, the processor may associate a fixed tie-breaker value v to each segment request, and the processor may prioritize the segment request with the higher scoring tie-breaker value whenever the indicated layer priority is the same. For example, such a tie-breaker value may be chosen pseudo-randomly or as a value from a low-discrepancy sequence.

In some embodiments, the processor may determine for each segment layer threshold success probabilities based on the priority of each layer. For example, the processor may determine a higher threshold for a segment base layer, and a lower priority for a higher segment layer, such that the overall success probability to receive is kept high, while the reception overhead remains reasonable. In some embodiments, the base layer threshold probability may be determined as a probability 1-p, the next layer may be determined as probability 1-2p, and so on.

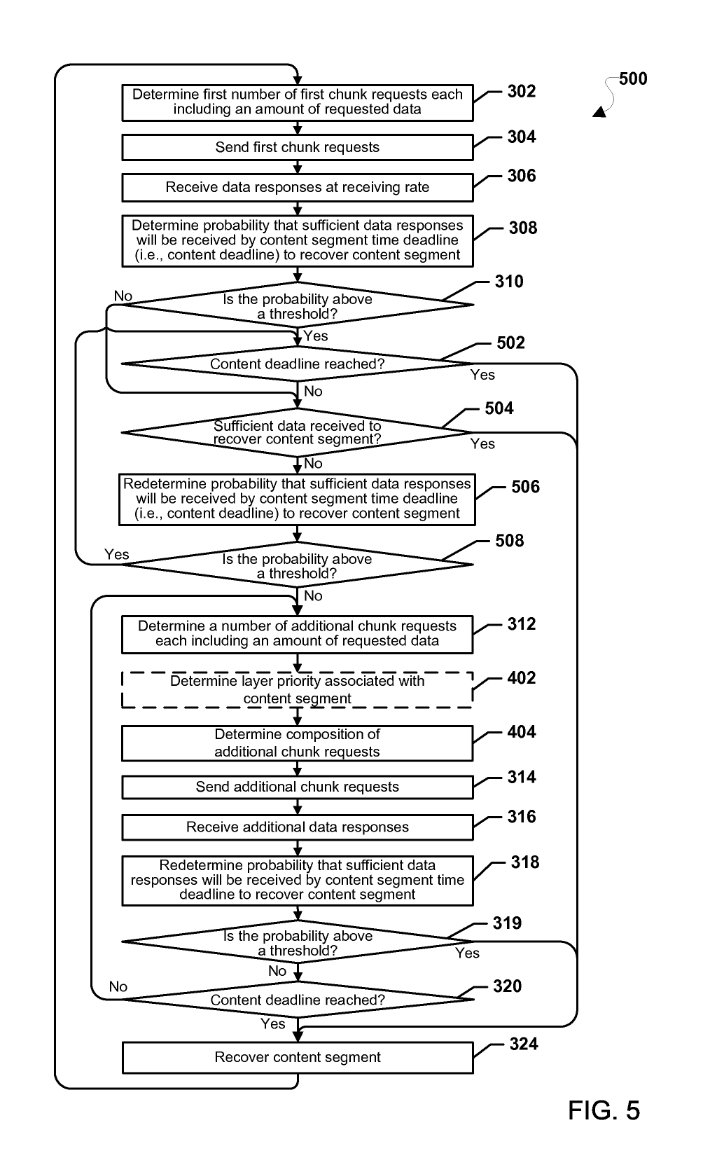

FIG. 5 illustrates another method 500 for managing data requests made by a request manager of a receiver device for delivery of content segments to the receiver device according to some embodiments. The method 500 may be implemented by a processor 202 of the receiver device performing or controlling operations of a request manager (e.g., the request manager 102a of FIG. 1). The processor may perform the operations of blocks 302 through 310 as described above with reference to FIGS. 3 and 4.

In determination block 310, the processor may determine whether the probability determined in block 308 is above a first threshold probability. In response to determining that the probability determined in block 308 is above the first threshold (i.e., determination block 310=“Yes”), the processor may determine whether the content deadline has been reached in determination block 502. In response to determining that the content deadline has been reached (i.e., determination block 502=“Yes”), the processor may recover the content segment in block 324. In this case, only a portion of the content segment may be recoverable, i.e., less than all of the content segment.

In response to determining that the content deadline has not been reached (i.e., determination block 502=“No”), the processor may determine whether sufficient data has been received to recover the content segment in determination block 504. In response to determining that sufficient data to recover the content segment has been received (i.e., determination block 504=“Yes”), the processor may recover the content segment in block 324.

In response to determining that sufficient data to recover the content segment has not been received (i.e., determination block 504=“No”), the processor may redetermine the probability that sufficient first data responses will be received by the request manager to enable the processor to decode or recover the content segment by the content segment time deadline (i.e., the time deadline associated with the content segment, also referred to as the content deadline) in block 506. In determination block 508, the processor may determine whether the redetermined probability is above the threshold. In response to determining that the redetermined probability is above the threshold (i.e., determination block 508=“Yes”), the processor may again determine whether the content deadline has been reached in determination block 502.

In response to determining that the redetermined probability is not above the threshold (i.e., determination block 508=“No”), the processor may determine a number of additional chunk requests in block 312. The processor may perform the operations of blocks 312-324 as described above with reference to FIGS. 3 and 4. In some embodiments, the processor may execute an instance of the method 500 for each of multiple content segments. Such executions may be sequential, concurrent, asynchronous, or any combination thereof. In some embodiments, certain decisions that are made in some executions may depend on other executions.

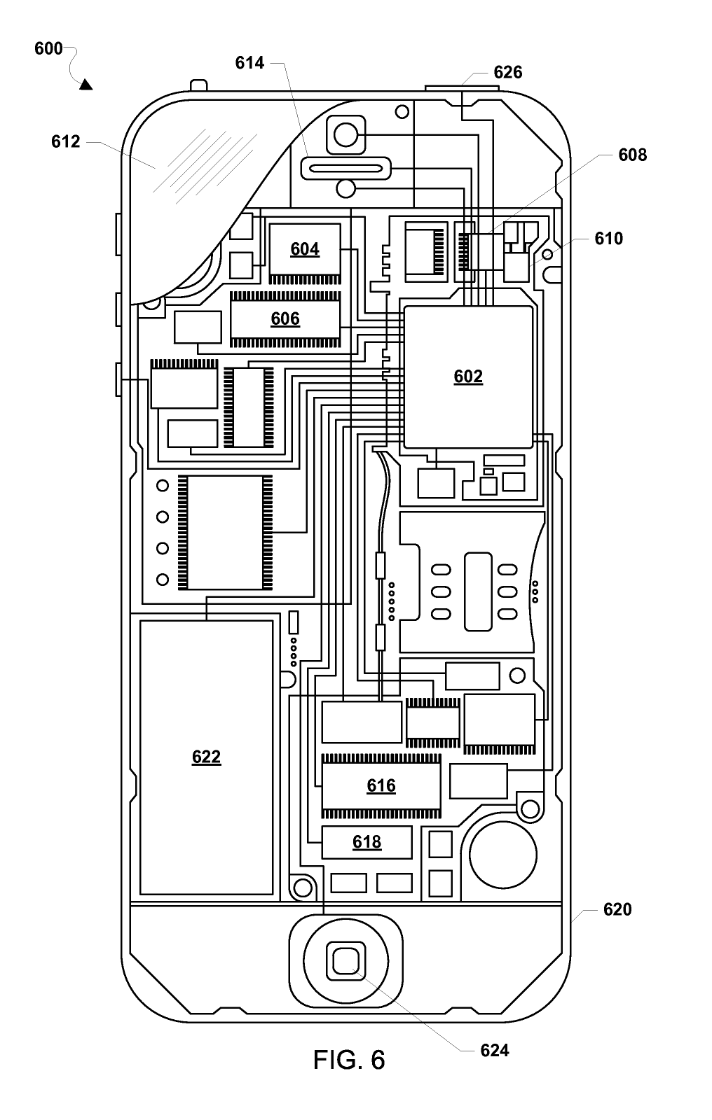

FIG. 6 is a component block diagram of a mobile communication device 600 suitable for implementing various embodiments, for instance, some or all of the methods illustrated in FIGS. 3-5. The mobile communication device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the mobile communication device 600 need not have touch screen capability.

The mobile communication device 600 may have two or more radio signal transceivers 608 (e.g., Peanut, Bluetooth, Zigbee, Wi-Fi, RF radio) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile communication device 600 may include one or more cellular network wireless modem chip(s) 616 coupled to the processor and antennae 610 that enables communication via two or more cellular networks via two or more radio access technologies.

The mobile communication device 600 may include a peripheral device connection interface 618 coupled to the processor 602. The peripheral device connection interface 618 may be singularly configured to accept one type of connection, or may be configured to accept various types of physical and communication connections, common or proprietary, such as USB, FireWire, Thunderbolt, or PCIe. The peripheral device connection interface 618 may also be coupled to a similarly configured peripheral device connection port (not shown).

The mobile communication device 600 may also include speakers 614 for providing audio outputs. The mobile communication device 600 may also include a housing 620, constructed of a plastic, metal, or a combination of materials, for containing all or some of the components discussed herein. The mobile communication device 600 may include a power source 622 coupled to the processor 602, such as a disposable or rechargeable battery. The rechargeable battery may also be coupled to the peripheral device connection port to receive a charging current from a source external to the mobile communication device 600. The mobile communication device 600 may also include a physical button 624 for receiving user inputs. The mobile communication device 600 may also include a power button 626 for turning the mobile communication device 600 on and off

The processor 602 may be any programmable microprocessor, microcomputer or multiple processor chip or chips that can be configured by software instructions (applications) to perform a variety of functions, including the functions of various embodiments described below. In some mobile communication devices, multiple processors 602 may be provided, such as one processor dedicated to wireless communication functions and one processor dedicated to running other applications. Typically, software applications may be stored in the internal memory 606 before they are accessed and loaded into the processor 602. The processor 602 may include internal memory sufficient to store the application software instructions.

The foregoing method descriptions, process flow diagrams, and call flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the various embodiments. Various modifications to these embodiments will be readily apparent to those skilled in the art, and the generic principles defined herein may be applied to other embodiments without departing from the spirit or scope of the various embodiments. Thus, the various embodiments are not intended to be limited to the embodiments shown herein but is to be accorded the widest scope consistent with the following claims and the principles and novel features disclosed herein.

What is claimed is:

1. A method for managing data requests made by a processor of a receiver device for delivery of content segments to the receiver device, comprising:
determining, by the processor, a first number of first chunk requests for a content segment, the first chunk requests identifying a first amount of requested data;
sending, from the receiver device to one or more servers, the first chunk requests;
receiving, by the receiver device from the one or more servers, first data responses to the first chunk requests at a receiving rate;
determining, by the processor, whether sufficient data responses to the first chunk requests might not be received by the receiver device to recover the content segment by a time deadline associated with the content segment;
determining, by the processor, a second number of one or more second chunk requests for the content segment and a second amount of data to request via the one or more second chunk requests in response to determining that sufficient data responses to the first chunk requests might not be received by the receiver device to recover the content segment by the time deadline associated with the content segment, wherein the second number and the second amount of data are based on the receiving rate of the first data responses and the time deadline associated with the content segment; and
sending the one or more second chunk requests from the receiver device to the one or more servers.

2. The method of claim 1, wherein determining, by the processor, whether sufficient data responses to the first chunk requests might not be received by the receiver device to recover the content segment by a time deadline associated with the content segment comprises determining a probability that sufficient data responses to the first chunk requests will be received by the receiver device to recover the content segment by the time deadline.

3. The method of claim 1, wherein the receiving rate is not predictable by the processor when the processor sends the first chunk requests.

4. The method of claim 1, wherein determining, by the processor, a second number of one or more second chunk requests for the content segment and a second amount of data comprises determining the second number of one or more second chunk requests and the second amount of data such that a probability that sufficient data responses to the first chunk requests and the one or more second chunk requests will be received by the receiver device to recover the content segment by the time deadline exceeds a defined threshold.

5. The method of claim 1, wherein the second amount of data to request via the one or more second chunk requests, which was determined in response to determining that sufficient data responses to the first chunk requests might not be received by the receiver device to recover the content segment by the time deadline associated with the content segment, comprises a composition based on the time deadline associated with the content segment, received data responses, and data responses not yet received, wherein the composition is one of additional source data of the content segment, repair data for the content segment, and a combination of repair data for and additional source data of the content segment.

6. The method of claim 5, wherein the composition is further based on a layer priority associated with the content segment.

7. The method of claim 5, wherein the composition comprises one or more of an amount of the additional source data of the content segment and an amount of repair data for the content segment, wherein the amount of the additional source data of the content segment and the amount of repair data for the content segment are based on one or more of the time deadline associated with the content segment, received data responses, data responses not yet received, and a layer priority associated with the content segment.

8. The method of claim 5, further comprising:
recovering the content segment when sufficient data responses to chunk requests to recover the content segment are received by the receiver device.

9. The method of claim 1, wherein the first chunk requests and the one or more second chunk requests comprise Hypertext Transfer Protocol/Transmission Control Protocol (HTTP/TCP) requests for one or more ranges of data of the content segment.

10. The method of claim 1, further comprising:
after sending the one or more second chunk requests to the one or more servers, determining, by the processor, whether sufficient data responses to the first chunk requests and the one or more second chunk requests might not be received by the receiver device to recover the content segment by the time deadline associated with the content segment;
determining, by the processor, a third number of one or more third chunk requests for the content segment and a third amount of data to request in response to determining that sufficient data responses to the first chunk requests and the one or more second chunk requests might not be received by the receiver device to recover the content segment by the time deadline associated with the content segment, wherein the third number and the third amount of data are based on a receiving rate of data responses to the first chunk requests and/or the one or more second chunk requests and the time deadline associated with the content segment; and
sending the one or more third chunk requests from the receiver device to the one or more servers.

11. A receiver device, comprising:
a processor configured with processor-executable instructions to perform operations comprising:
determining a first number of first chunk requests for a content segment, the first chunk requests identifying a first amount of requested data;
sending the first chunk requests to one or more servers;
receiving, from the one or more servers, first data responses to the first chunk requests at a receiving rate;
determining whether sufficient data responses to the first chunk requests might not be received to recover the content segment by a time deadline associated with the content segment;
determining a second number of one or more second chunk requests for the content segment and a second amount of data to request via the one or more second chunk requests in response to determining that sufficient data responses to the first chunk requests might not be received to recover the content segment by the time deadline associated with the content segment, wherein the second number and the second amount of data are based on the receiving rate of the first data responses and the time deadline associated with the content segment; and
sending the one or more second chunk requests to the one or more servers.

12. The receiver device of claim 11, wherein the processor is configured with processor-executable instructions to perform operations such that determining whether sufficient data responses to the first chunk requests might not be received to recover the content segment by a time deadline associated with the content segment comprises determining a probability that sufficient data responses to the first chunk requests will be received to recover the content segment by the time deadline.

13. The receiver device of claim 11, wherein the processor is configured with processor-executable instructions to perform operations such that the receiving rate is not predictable by the processor when the processor sends the first chunk requests.

14. The receiver device of claim 11, wherein the processor is configured with processor-executable instructions to perform operations such that determining a second number of one or more second chunk requests for the content segment and a second amount of data comprises determining the second number of one or more second chunk requests and the second amount of data such that a probability that sufficient data responses to the first chunk requests and the one or more second chunk requests will be received to recover the content segment by the time deadline exceeds a defined threshold.

15. The receiver device of claim 11, wherein the processor is configured with processor-executable instructions to perform operations such that the second amount of data to request via the one or more second chunk requests, which was determined in response to determining that sufficient data responses to the first chunk requests might not be received to recover the content segment by the time deadline associated with the content segment, comprises a composition based on the time deadline associated with the content segment, received data responses, and data responses not yet received, wherein the composition is one of additional source data of the content segment, repair data for the content segment, and a combination of repair data for and additional source data of the content segment.

16. The receiver device of claim 15, wherein the processor is configured with processor-executable instructions to perform operations such that the composition is further based on a layer priority associated with the content segment.

17. The receiver device of claim 15, wherein the processor is configured with processor-executable instructions to perform operations such that the composition comprises one or more of an amount of the additional source data of the content segment and an amount of repair data for the content segment, wherein the amount of the additional source data of the content segment and the amount of repair data for the content segment are based on one or more of the time deadline associated with the content segment, received data responses, data responses not yet received, and a layer priority associated with the content segment.

18. The receiver device of claim 15, wherein the processor is configured with processor-executable instructions to perform operations further comprising recovering the content segment when sufficient data responses to chunk requests to recover the content segment are received.

19. The receiver device of claim 11, wherein the first chunk requests and the one or more second chunk requests comprise Hypertext Transfer Protocol/Transmission Control Protocol (HTTP/TCP) requests for one or more ranges of data of the content segment.

20. The receiver device of claim 11, wherein the processor is configured with processor-executable instructions to perform operations further comprising:
after sending the one or more second chunk requests to the one or more servers, determining whether sufficient data responses to the first chunk requests and the one or more second chunk requests might not be received to recover the content segment by the time deadline associated with the content segment;
determining a third number of one or more third chunk requests for the content segment and a third amount of data to request in response to determining that sufficient data responses to the first chunk requests and the one or more second chunk requests might not be received to recover the content segment by the time deadline associated with the content segment, wherein the third number and the third amount of data are based on a receiving rate of data responses to the first chunk requests and/or the one or more second chunk requests and the time deadline associated with the content segment; and
sending the one or more third chunk requests to the one or more servers.

21. A non-transitory processor-readable storage medium having stored thereon processor-executable instructions configured to cause a processor of a receiver device to perform operations comprising:
determining a first number of first chunk requests for a content segment, the first chunk requests identifying a first amount of requested data;
sending the first chunk requests to one or more servers;
receiving, from the one or more servers, first data responses to the first chunk requests at a receiving rate;
determining whether sufficient data responses to the first chunk requests might not be received to recover the content segment by a time deadline associated with the content segment;
determining a second number of one or more second chunk requests for the content segment and a second amount of data to request via the one or more second chunk requests in response to determining that sufficient data responses to the first chunk requests might not be received to recover the content segment by the time deadline associated with the content segment, wherein the second number and the second amount of data are based on the receiving rate of the first data responses and the time deadline associated with the content segment; and
sending the one or more second chunk requests to the one or more servers.

22. The non-transitory processor-readable storage medium of claim 21, wherein the stored processor-executable instructions are configured to cause a processor of a receiver device to perform operations such that determining whether sufficient data responses to the first chunk requests might not be received to recover the content segment by a time deadline associated with the content segment comprises determining a probability that sufficient data responses to the first chunk requests will be received to recover the content segment by the time deadline.

23. The non-transitory processor-readable storage medium of claim 21, wherein the stored processor-executable instructions are configured to cause a processor of a receiver device to perform operations such that the receiving rate is not predictable by the processor when the processor sends the first chunk requests.

24. The non-transitory processor-readable storage medium of claim 21, wherein the stored processor-executable instructions are configured to cause a processor of a receiver device to perform operations such that determining a second number of one or more second chunk requests for the content segment and a second amount of data comprises determining the second number of one or more second chunk requests and the second amount of data such that a probability that sufficient data responses to the first chunk requests and the one or more second chunk requests will be received to recover the content segment by the time deadline exceeds a defined threshold.

25. The non-transitory processor-readable storage medium of claim 21, wherein the stored processor-executable instructions are configured to cause a processor of a receiver device to perform operations such that the second amount of data to request via the one or more second chunk requests, which was determined in response to determining that sufficient data responses to the first chunk requests might not be received to recover the content segment by the time deadline associated with the content segment, comprises a composition based on the time deadline associated with the content segment, received data responses, and data responses not yet received, wherein the composition is one of additional source data of the content segment, repair data for the content segment, and a combination of repair data for and additional source data of the content segment.

26. The non-transitory processor-readable storage medium of claim 25, wherein the stored processor-executable instructions are configured to cause a processor of a receiver device to perform operations such that the composition is further based on a layer priority associated with the content segment.

27. The non-transitory processor-readable storage medium of claim 25, wherein the stored processor-executable instructions are configured to cause a processor of a receiver device to perform operations such that the composition comprises one or more of an amount of the additional source data of the content segment and an amount of repair data for the content segment, wherein the amount of the additional source data of the content segment and the amount of repair data for the content segment are based on one or more of the time deadline associated with the content segment, received data responses, data responses not yet received, and a layer priority associated with the content segment.

28. The non-transitory processor-readable storage medium of claim 25, wherein the stored processor-executable instructions are configured to cause a processor of a receiver device to perform operations further comprising recovering the content segment when sufficient data responses to chunk requests to recover the content segment are received.

29. The non-transitory processor-readable storage medium of claim 21, wherein the first chunk requests and the one or more second chunk requests comprise Hypertext Transfer Protocol/Transmission Control Protocol (HTTP/TCP) requests for one or more ranges of data of the content segment.

30. A receiver device, comprising:
means for determining a first number of first chunk requests for a content segment, the first chunk requests identifying a first amount of requested data;
means for sending the first chunk requests to one or more servers;
means for receiving, from the one or more servers, first data responses to the first chunk requests at a receiving rate;
means for determining whether sufficient data responses to the first chunk requests might not be received to recover the content segment by a time deadline associated with the content segment;
means for determining a second number of one or more second chunk requests for the content segment and a second amount of data to request via the one or more second chunk requests in response to determining that sufficient data responses to the first chunk requests might not be received to recover the content segment by the time deadline associated with the content segment, wherein the second number and the second amount of data are based on the receiving rate of the first data responses and the time deadline associated with the content segment; and
means for sending the one or more second chunk requests to the one or more servers.
